(19) United States
(12) Patent Application Publication
(10) Pub. No.: US 2009/0127362 A1
(43) Pub. Date: May 21, 2009

(54) Roller mill for comminuting solid materials

(75) Inventors: Jason S. Euculano, Northampton, PA (US); Dwayne R. Schantz, Coopersburg, PA (US)

Correspondence Address: Daniel DeJoseph;F.L.Smidth Inc., 2040 Avenue C, Bethlehem, PA, 18017-2188, US

(73) Assignee: FLSmidth A/S

(21) Appl. No.: 11/985,629

(22) Filed: Nov. 16, 2007

(51) Int. Cl. B02C 15/00

(52) U.S. Cl. 241/117

(57) ABSTRACT

A roller mill for comminuting solid material having a mixture of hard and soft components which is capable of acting on the solid material at two or more distinct pressures to thereby comminute both hard and soft components of the solid material.

### BACKGROUND OF THE INVENTION

This invention relates to a comminution device, and in particular a vertical roller mill, for comminuting solid materials such as coal, cement raw meal, cement clinker and ores. More particularly, the invention relates to an improved apparatus for grinding such materials that is capable of efficiently grinding a solid material mixture having a harder material component and a softer material component.

The vertical roller mill for use in the present invention includes a casing or mill body with a generally horizontal grinding table positioned within that casing and mounted for rotation about a vertical axis. Suitable drive means such as a motor and gear reducer are provided for rotating the table. One or more rollers are also mounted in the casing for rotation about an axis which is at some angle to the table. A rocker arm exerts a downward force on the roller so that a bed of material on the table will have compressive and shear forces applied to the material by the roller to thereby comminute the material. Typically, a hydraulic actuator such as a hydraulic piston-cylinder apparatus pulls on the rocker arm so that the rocker arm pivots about its connection to the mill body and a downward force is exerted on the grinding roll. Mills of the type to which the present invention relates are shown for example in U.S. Pat. Nos. 7,028,934; 4,828,189 and 4,694,997.

It is common when grinding materials for there to be a mix of materials which require differing amounts of force. A harder raw mill component will typically require a higher amount of force to be successfully comminuted, while a softer raw mill component will require a lower amount of force. As an example, the presence of a mixture of raw material components having hardness factors that fall within two distinct ranges typically requires the mill operator to select a grinding force which would fall into any of the following three categories:
(1) A high force is selected to optimally grind the harder raw components, which tends to over-grind the softer raw component, thus wasting power and having lower grinding efficiency.
(2) A low force is selected to optimally grind the softer raw components, which tends to under-grind the harder raw component, thus using less power, but at the expense of having the mill “load up” with the harder raw component and potentially causing an increase in the abrasive wear of mill parts.
(3) A middle force is selected, somewhere between the high and low force values, in an attempt to reach a compromise grinding efficiency while actually achieving in over-grinding the softer components and under-grinding the harder components.

One prior art method of addressing this problem is commonly referred to as a dual hydraulics roller mill, where a four-roller mill is divided into two roller pairs. Each pair has an independent force setting, allowing one pair of rollers to be optimized for the harder raw component and the second pair of rollers to be optimized for the softer raw component. However, this method can not be advantageously utilized on mills having an uneven number of rollers or less than four rollers.

It is the principal object of this invention to provide an improved comminution device for comminuting solid material such as coal, ores and cement clinkers which includes an improved apparatus for exerting a downward grinding force or pressure on the material to be comminuted when such material is a mixture of at least two materials having differing hardness.

It is another object of the present invention to have a mill that can automatically go from a first to a second (and optionally a third or more) force setting to more efficiently grind a feed stock having components with different hardness.

It is yet another object of the present invention to have a roller mill that is capable of grinding at two distinct force settings while having one, two or an uneven number of rollers.

It is a further object to have a mill utilizing two or more force settings which does not utilize a dual-hydraulics system.

### BRIEF DESCRIPTION OF THE INVENTION

In general, the foregoing and other objects will be carried out by the present invention which broadly includes a device for comminuting a solid material mixture having hardness factors that fall within two distinct ranges comprising at least two comminution elements that cooperate to form a material comminution area between them to which material is delivered, with at least one of said comminution elements being movable relative to such material. The device will operate at a lower pressure to comminute the softer material component, and then will convert to operate at a higher pressure suitable to comminute the harder material. The conversion from a lower to a higher operating pressure and back again to the lower operating pressure can be accomplished manually, automatically according to a predetermined timing sequence, or automatically based on operational feedback.

When the comminution device of the present invention is a roller mill the at least two comminution elements that cooperate to form a material comminution area between them are a mill table and a mill roller movable relative to the solid material mixture to be comminuted. The material to be comminuted is delivered onto the mill table. The mill typically has more than one mill roller. The mill will employ a pressure transferring medium, preferably a hydraulic-pneumatic tensioning system, to move the mill roller against the material to apply pressure (alternatively referred to as grinding force) to the material. According to the present invention, the system can apply comminution forces at two or more pressure settings. The system will primarily operate at a lower force setting to sufficiently break up the softer components in the solid mixture, thus providing for a high grinding efficiency. At a prescribed activation interval, however, one or more mill rollers will have a hydraulic pressure “pulse” applied to them to operate at a higher pressure setting for a sufficient period so that harder raw components are broken into small enough particles which are then removed by the mill's air stream or are further acted upon by the rollers at a lower pressure. This allows the mill to run at optimal grinding efficiency most of the time, but also provides a means of breaking down and removing the harder materials and increasing life of mill parts.

The pressure pulse hydraulic system preferably has a hydraulic pressure delivering device such as a hydraulic accumulator is activated for delivering hydraulic energy at a high pressure. When the pressure pulse is activated the hydraulic delivering device rapidly discharges a portion of stored or newly created energy, thus causing the hydraulic grinding pressure to “pulse”. When the pressure pulse is deactivated hydraulic fluid will flow back into the delivering device system or tank thus causing the hydraulic grinding pressure to revert to the lower operating level.

### BRIEF DESCRIPTION OF THE DRAWINGS

The invention will be described in connection with the annexed drawings wherein;

FIG. 1 is an view of a vertical roller mill according to one embodiment of the present invention;

FIG. 2 is a basic simplified schematic representation of a hydraulic system which may be utilized in the present invention.

### DETAILED DESCRIPTION OF THE DRAWINGS

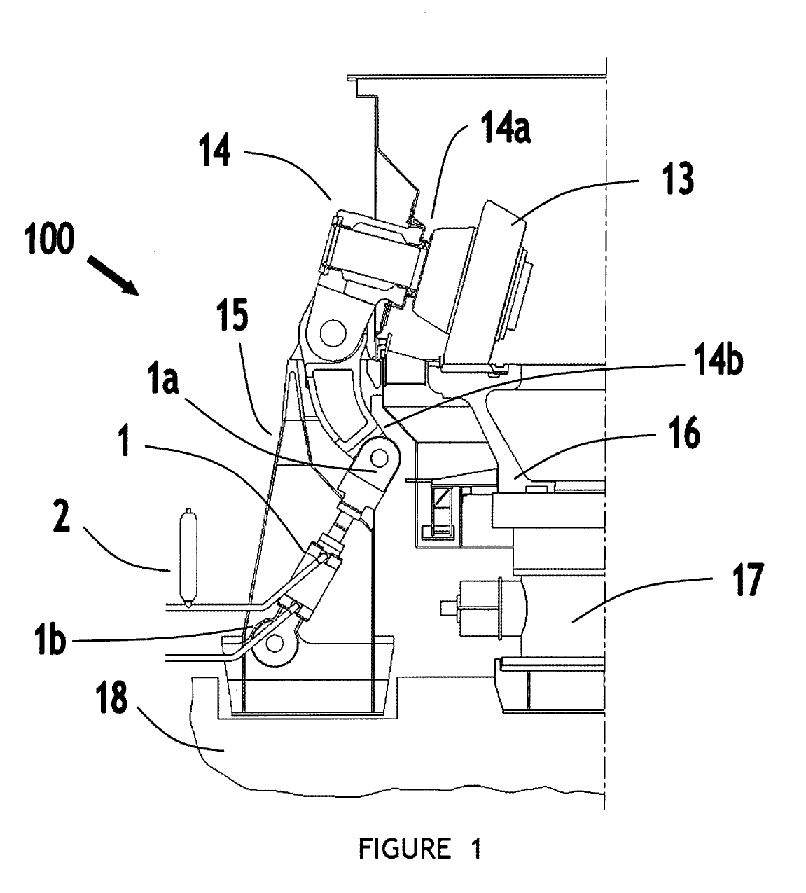

The preferred embodiment of the present invention relates to a vertical roller mill of the type shown in FIG. 1 and includes a mill body generally indicated at 100 comprising a mill stand 15 mounted on a suitable foundation 18. The roller mill includes a horizontal grinding table 16 mounted for rotation about a vertical axis. The table 16 may be suitably connected to a drive motor (not shown) through a main drive gearbox 17.

The mill also includes at least one and preferably two to six, and most preferably two to four grinding rollers 13 each mounted for rotation about an axis which is at an angle to the table 16. A rocker arm generally indicated at 14 is pivotally mounted to exert a downward force on roller 13, which is mounted on end 14a of rocker arm 14. The apparatus includes a hydraulic piston-cylinder 1 with the piston rod 1a pivotally connected to the other end 14b of rocker arm 14. Hydraulic piston-cylinder 1 is suitably connected to a source of an essentially non-compressible hydraulic fluid under pressure (depicted in FIG. 1 as accumulator 2) in the line. Piston cylinder 1 is pivotally connected at 1b to the mill body and mill stand 2. As hydraulic fluid is supplied to cylinder 1, and will generate a force urging piston rod 1a downwardly so that the rocker arm assembly 14 exerts a downward force on the roller 13. The roller 13 cooperates with the grinding table 16 so that a bed of material on the table 16 is comminuted by compression and shear forces applied by the downward force and rotary motion of the rollers.

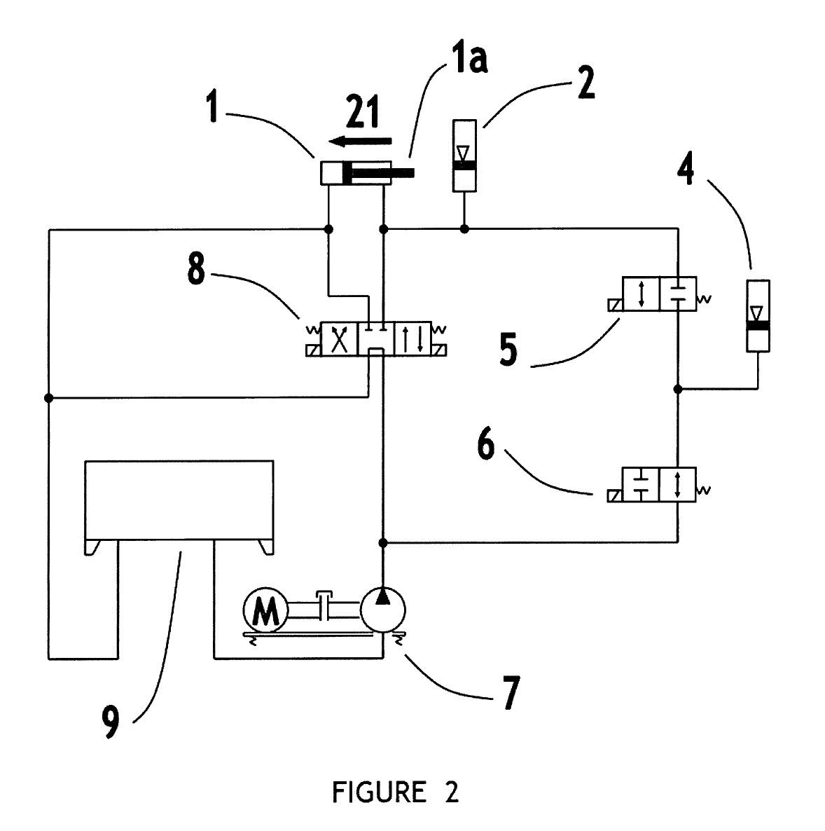

The embodiment depicted in FIG. 1 is essentially conventional and depicts a method of exerting a first force on piston cylinder 1 and consequently roller 13. FIG. 2 illustrates the method of present invention of introducing a second force on piston cylinder 1, to thereby increase the grinding forces on the bed of material.

In FIG. 2 hydraulic piston-cylinder 1, piston rod 1a, and accumulator 2 are as described in FIG. 1. As piston rod moves in the direction of arrow 21, the force applied to roller 13 (not depicted in FIG. 2) is increased. A first pressure delivering device, depicted as accumulator 2 (or other suitable pressure delivering devices such as a hydraulic pump) is configured to act in a first fluid pressure transferring relationship with cylinder 1 so that, when activated, it will transmit a first pressure to cylinder 1, which first pressure functions as the lower mill operating pressure to which the roller 13, and consequently the solid material mixture, is subject and which is typically predetermined by the mill operator based on the hardness characteristics of the solid material mixture. A second pressure delivering device, depicted as accumulator 4, is configured to act in a second fluid pressure transferring relationship with cylinder 1 so that, when activated, it will transfer a second pressure to cylinder 1, which second pressure will combine in the cylinder with said first pressure to function in combination as the upper mill operating pressure. Said upper mill operating pressure is also typically predetermined by the mill operator.

The activation of the second pressure delivering device to transmit stored (in the case of an accumulator) or newly created (in the case of a hydraulic pump) pressure to cylinder one can be done manually by the operator, automatically based on a predetermining timing sequence or automatically based on operational feedback. In the latter two instances appropriate central controls, PLC's and sensing devices would be added to the operational hydraulic circuit as necessary in a manner well known in the art.

Further to FIG. 2, second pressure directional control valve 5 is depicted in a de-energized position to prevent pressure being transmitted from accumulator 2 to cylinder 1 and thus allow the mill to operate at the lower pressure. When energized the second pressure will be transmitted to the hydraulic cylinder to combine with the first force. Hydraulic system pump 7 (depicted with motor) serves to pressurize either side of the grinding system cylinder to thereby apply grinding force to or remove grinding force from the roller mill. Pump 7 is utilized in conjunction with hydraulic system directional control valve 8 which directs hydraulic fluid to either side of the grinding system cylinder or remains in a “neutral” position. Hydraulic system reservoir 9 stores hydraulic fluid in a non-pressurized environment and operates in conjunction with second pressure directional control valve 6 which, when de-energized, allows pulse pressure to drain back to reservoir 9 and, when energized, allows pump 7 to build up pressure in accumulator 5. Second pressure directional control valve 5 can be configured to allow the second force to build up in cylinder 1 at a controlled rate, rather than having the cylinder quickly jump from the lower pressure to the higher pressure.

The mill should generally operate at the higher pressure for from 5% to about 15% of the total operational time, although the actual percentage will depend on the composition of the solid material mixture.

From the foregoing it can be seen that a novel apparatus for exerting at least two distinct downward forces material to be comminuted by a vertical roller mill has been provided. It is intended that the foregoing be a description of a preferred embodiment and that the invention be limited solely by that which is within the scope of the impended claims.

We claim:

1. A device for comminuting solid material having a mixture of hard and soft components comprising a first comminution element and a second comminution element cooperating therewith to form a solid material comminution area between such elements, with at least one of said comminution elements being movable in relation to solid material located in said material comminution area, wherein said at least one movable comminution element is capable of acting upon said solid material located in said material comminution area at two or more distinct operating pressures.

2. The device of claim 1 wherein the at least one movable comminution element is capable of acting upon said solid material at two distinct operating pressures: a lower operating pressure and a higher operating pressure.

3. The device of claim 2 wherein changing the operation of the device between the lower operating pressure and the higher operating pressure is controlled manually.

4. The device of claim 2 wherein changing the operation of the device between the lower operating pressure and the higher operating pressure is controlled automatically.

5. The device of claim 4 wherein the device is maintained at the lower operating pressure for a first predetermined time period and at the higher operating pressure for a second predetermined time period.

6. The device of claim 5 wherein the second predetermined time period is of less duration that said first predetermined time period.

7. The device of claim 4 wherein changing the operation of the device between the lower and higher operating pressures is controlled automatically by having the device be responsive to operational feedback conditions.

8. The device of claim 2 further comprising a first pressure delivering device that is capable upon activation of being in a pressure transferring relationship with the one movable comminution element, and whereby upon activation a first predetermined pressure is transmitted to the at least one movable comminution element to thereby enable the at least one movable comminution element to act upon said solid material at the lower operating pressure.

9. The device of claim 8 further comprising a second pressure delivering device that is capable upon activation of being in a pressure transferring relationship with the one movable comminution element whereby upon activation a second predetermined pressure is transmitted to the at least one movable comminution element, wherein further the first and second predetermined pressures in concert enable the at least one movable comminution element to act upon said solid material at the higher operating pressure.

10. The device of claim 9 wherein both the first pressure delivering device and the second pressure delivering device are accumulators.

11. The device of claim 10 which is a roller mill, wherein the first comminution element is a mill roller which is movable in relation to the solid material and the second comminution element is a generally horizontal grinding table.

12. A roller mill for comminuting solid material having a mixture of hard and soft components comprising a mill body, a generally horizontal grinding table mounted in said mill body for rotation about a vertical axis and at least one grinding roller mounted in said body for rotation about an axis which is at an angle to the axis of rotation of the grinding table for cooperation with said grinding table to thereby comminute the solid material between the grinding table and said at least one grinding roller, said at least one grinding roller being capable of acting on the solid material at two or more distinct pressures to thereby comminute both hard and soft components of the solid material.

13. The roller mill of claim 12 wherein the at least one grinding roller is capable of acting upon said solid material at two distinct pressures: a lower predetermined pressure to comminute soft components of the solid material mixture and a higher predetermined pressure to comminute hard components of the solid material mixture.

14. The roller mill of claim 13 further comprising a first pressurized hydraulic fluid accumulator that is capable upon activation of being in a pressure transferring relationship with the at least one grinding roller whereby upon activation a first predetermined pressure is transmitted to the at least one grinding roller to thereby enable the at least one grinding roller to act upon said solid material at said lower predetermined pressure.

15. The device of claim 14 further comprising a second pressurized hydraulic fluid accumulator that is capable upon activation of being in a pressure transferring relationship with the one movable grinding roller whereby upon activation a second predetermined pressure is transmitted to the at least one movable grinding roller, wherein further the first and second predetermined pressures in concert enable the at least one movable grinding roller to act upon said solid material at the higher operating pressure.
